(19) United States
(12) Patent Application Publication
(10) Pub. No.: US 2017/0137675 A1
(43) Pub. Date: May 18, 2017

(54) METHOD FOR BONDING AND BONDING MIXTURE

(71) Applicant: Mehler Engineered Products GmbH, Fulda (DE)

(72) Inventor: Jens KIESEWETTER, Kuenzell (DE)

(73) Assignee: Mehler Engineered Products GmbH, Fulda (DE)

(21) Appl. No.: 15/419,004

(22) Filed: Jan. 30, 2017

Related U.S. Application Data
(63) Continuation of application No. PCT/EP2015/067239, filed on Jul. 28, 2015.

(30) Foreign Application Priority Data
Jul. 29, 2014 (DE) 10 2014 214 858.8

(51) Int. Cl. C09J 107/02; C09J 5/00; C09J 109/04; C09J 111/02; C09J 139/08; C09J 109/08

(52) U.S. Cl. CPC C09J 107/02; C09J 139/08; C09J 109/08; C09J 109/04; C09J 111/02; C09J 5/00

(57) ABSTRACT

A method for bonding and a bonding mixture for the bonding of a textile to a rubber component, wherein the bonding mixture comprises at least one latex and one formaldehyde-free crosslinker, wherein the crosslinker comprises at least one substance from at least one of oxazolidines, quinone dioximes, and/or maleinized polybutadienes.

This nonprovisional application is a continuation of International Application No. PCT/EP2015/067239, which was filed on Jul. 28, 2015, and which claims priority to German Patent Application No. DE 10 2014 214 858.8, which was filed in Germany on Jul. 29, 2014, and which are both herein incorporated by reference.

### BACKGROUND OF THE INVENTION

Field of the Invention

The invention relates to a bonding mixture for bonding a textile to a rubber component and a method for bonding, via a bonding mixture, a textile to a rubber component.

Description of the Background Art

For a variety of products, technical textiles are combined with a rubber component. To prepare this compound, bonding mixtures are known which crosslink both with the rubber component and also produce a compound with the textile component.

The so-called RFL system (resorcinol-formaldehyde latex) has long been known as a bonding mixture.

In this case, the textile is impregnated with a latex bonding mixture and a condensate of resorcinol and formaldehyde. As a rule, the rubber-friendly equipment consists of a latex (usually styrene-butadiene-vinylpyridine terpolymer or chloroprene, rarely natural rubber (increased tackiness)) and a resorcinol-formaldehyde precondensate as well as occasional waxes or tackifiers. The reaction product of these substances is decisive for the properties of the dips, such as: viscosity, resistance, adhesive strength, flexibility.

From JP 002007238903 A, a rubber mixture and its use in a pneumatic tire are disclosed. The rubber mixture comprises at least one rubber component from the group consisting of natural rubber and synthetic rubber, as well as a component having a radical Q comprising divalent nitrogen and a heterocyclic ring radical B comprising oxygen or sulfur and 4 to 6 nitrogen groups, and an oil.

DE 603 08 115 T2, which corresponds to US 2004/0024093, discloses a caoutchouc composition comprising at least one diene-based elastomer, a starch-plasticizer composite material and an adduct of maleic anhydride and polybutadiene, and pneumatic tires having at least one component made of such caoutchouc composition. Such a tire component can, for example, be the longitudinal tread or other component of the tire.

DE 43 08 528 C2 discloses a method for the manufacture of caoutchouc/caoutchouc and caoutchouc/rubber compounds with dynamic and static strengths in a size as required for conveyor belts, using an unvulcanized rubber applied in liquid form which fully vulcanizes with vulcanization aids after application and in contact with the surfaces to be bonded, wherein an aqueous dispersed halogen-containing butadiene rubber having at least one blocked isocyanate is used as a bonding agent, and a metal oxide is used as a vulcanization aid.

DE 10 2005 013 863 A1, which corresponds to US 2005/0215667, discloses a curable or cross-linkable composition of the thermally cross-linkable type, having the following excellent benefits and properties: It does not require any polyvinyl chloride resin and exhibits excellent adhesion also to aluminum alloy materials and the like. The curable or cross-linkable composition is characterized in that a diluent and an adhesion promoter are mixed (compounded) with a composition comprising a synthetic rubber of the non-crosslinked type and/or partially crosslinked type, a plasticizer, a filler and a core-shell type acrylic resin. Preferred diluents are paraffin or naphthenic hydrocarbons produced by distillation of crude oil or chemically synthesized hydrocarbons, which are a second or third class oil (petroleum) having a molecular weight of 200 or less.

DE 691 10 161 T2, which corresponds to U.S. Pat. No. 5,100,964, discloses a rubber mixture comprising synthetic rubber, wherein the mixture comprises (a) 100 parts by weight of a synthetic rubber, and (b) from 0.5 to 10 parts by weight of an alkylene oxide adduct of a saponified copolymer of ethylene and a vinyl ester of a saturated carboxylic acid.

### SUMMARY OF THE INVENTION

It is therefore an object of the present invention is to provide a method for bonding via a bonding mixture and an improved bonding mixture.

According to an exemplary embodiment of the invention, a bonding mixture for the bonding of a textile to a rubber component comprises at least one latex and one formaldehyde-free crosslinker, wherein the crosslinker comprises at least one substance from at least one of the groups: oxazolidines, quinone dioximes, and/or maleinized polybutadienes.

The crosslinker may include at least one substance from at least one of the groups: reactive but blocked aliphatic isocyanates, and/or thermally cross-linkable polyacrylates.

The substances of the abovementioned groups allow for a bonding mixture in which formaldehyde (methanal) can be eliminated.

Formaldehyde is considered to be carcinogenic. As a result of the elimination of the formaldehyde, the toxicity of the bonding mixture can be drastically reduced.

The bonding mixture according to the invention makes it possible to achieve adhesion of rubber components to textiles which is at least as durable, temperature-resistant and lasting as those obtained by the known RFL adhesive mixtures. In addition, the bonding mixture according to the invention is inexpensive.

In an embodiment of the invention, a resorcinol resin (1,3-dihydroxybenzene) can also be eliminated by using the mentioned substances in the crosslinker.

In this way, the toxic potential of the bonding mixture is further reduced.

A resorcinol resin can be contained in the crosslinker.

In an exemplary embodiment, the latex can be a vinylpyridine latex (VP), styrene-butadiene latex (SBR), nitrile-butadiene latex (NBR), styrene-butadiene-vinylpyridine terpolymer, chloroprene (CR) or natural rubber or a mixture of at least two of said components.

The bonding mixture may further comprise at least one wax and/or at least one tackifier.

According to an exemplary embodiment the invention, the bonding mixture can be used to bond, for example, a textile to a rubber component.

The bonding mixture can be prepared in a two-stage process. In a first stage, the crosslinker is prepared, which is subsequently mixed with latex. As a rubber component, SBR latex can be used in a blend with vinylpyridine latex. After a curing time (for example, about 6 hours), the bonding mixture is applied to the textile, pre-dried at elevated temperature (for example 100° C. to 130° C.) and finally reacted with the fibers of the textile in a main dryer at a further elevated temperature (for example 150° C. to 230° C.). At the same time, the crosslinker also reacts with the rubber component of the latex. A connection with the matrix of the rubber component is effected by covulcanization. Nitrile rubber latices may be used for polar rubber.

The bonding mixture can be used, for example, for producing a tire, a rubber chain for a crawler type vehicle, a V-belt, a toothed belt, a hose, a molded hose, a conveyor belt or a rubberized garment.

Moreover, the bonding mixture according to the invention can replace the known RFL system in any area of application when bonding a textile to a rubber component.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for bonding a textile to a rubber component via a bonding mixture, the method comprising:
providing the bonding mixture with at least one latex and one formaldehyde-free crosslinker, the crosslinker comprising at least one substance from at least one of the groups: oxazolidines, quinone dioximes, and/or maleinized polybutadienes; and
applying the bonding mixture to bond the rubber component to the textile.

2. The method according to claim 1, wherein the crosslinker is free of resorcinol resin.

3. The method according to claim 1, wherein the latex is a vinylpyridine latex, styrene-butadiene latex, nitrile-butadiene latex, styrene-butadiene-vinylpyridine terpolymer, chloroprene or natural rubber.

4. The method according to claim 1, wherein the bonding mixture further comprises a wax.

5. The method according to claim 1, wherein the bonding mixture further comprises a tackifier.

6. The method according to claim 1, wherein the rubber component is a tire, a rubber chain for a crawler, a V-belt, a toothed belt, a hose, a molded hose, a conveyor belt or a rubberized garment.

7. A bonding mixture for bonding a textile to a rubber component, wherein the bonding mixture comprises at least one latex and one formaldehyde-free crosslinker, wherein the crosslinker comprises at least one substance from at least one of the groups: oxazolidines, quinone dioximes, and/or maleinized polybutadienes.

8. The bonding mixture according to claim 7, wherein the crosslinker is free from resorcinol resin.

9. The bonding mixture according to claim 7, wherein the latex is a vinylpyridine latex, styrene-butadiene latex, nitrile-butadiene latex, styrene-butadiene-vinylpyridine terpolymer, chloroprene or natural rubber.

10. The bonding mixture according to claim 7, wherein the bonding mixture further comprises a wax.

11. The bonding mixture according to claim 7, wherein the bonding mixture further comprises a tackifier.
